(19) United States
(12) Patent Application Publication
(10) Pub. No.: US 2019/0341682 A1
(43) Pub. Date: Nov. 7, 2019

(54) ANTENNA AND ANTENNA CONTROL METHOD

(71) Applicant: ZTE CORPORATION, Shenzhen, Guangdong (CN)

(72) Inventor: Kai Ma, Shenzhen, Guangdong (CN)

(21) Appl. No.: 16/474,567

(22) PCT Filed: Dec. 27, 2017
(86) PCT No.: PCT/CN2017/118962

§ 371 Date: Jun. 28, 2019

(30) Foreign Application Priority Data
Jan. 3, 2017 (CN) 201710001232.2

(51) Int. Cl. H01Q 1/36; H01Q 3/01; H01Q 23/00

(52) U.S. Cl. CPC H01Q 1/364; H01Q 23/00; H01Q 3/01

(57) ABSTRACT

Disclosed are an antenna and an antenna control method, wherein the substrate is placed below the control circuit board; the substrate is provided with a matrix channel; the matrix channel includes at least one liquid channel; each liquid channel is used for bearing a liquid in a liquid form at a normal temperature and containing iron particles; the control circuit board is provided with a matrix coil corresponding to the matrix channel; the matrix coil includes at least one conductive coil corresponding to the liquid channel; and the control circuit board is used for controlling, according to the shape of a required antenna, each conductive coil conducted in the matrix coil, so that same generates a magnetic field, and for controlling a state change of the iron particles in the liquid channel corresponding to the conducted conductive coils, so as to form an antenna with a target shape.

### FIELD OF THE INVENTION

The present disclosure relates to the technical field of antennas, for example, to an antenna and an antenna control method.

### BACKGROUND OF THE INVENTION

With the development of communication technologies, the integration degree of a mobile terminal (such as a mobile phone) is increasingly higher. However, the antenna, constrained by the law of Chu-Harrington, has limited physical volume, and thus it is impossible for the antenna to have excellent performance. Moreover, with the use of multiple antennas in the mobile terminal, problems such as the isolation degree among the multiple antennas become prominent, and it is increasingly difficult for performance of a multi-band antenna in a narrow space and an unfavorable environment to meet people's requirements.

In recent years, with the rapid development and popularization of mobile terminals, it has become a main trend that the mobile terminal such as the mobile phone supports the Fourth Generation (4G) mobile communication technology, and operators have taken a step towards the commercialization development of the Long Term Evolution-Advanced (LTE-A) technology. In order to meet requirements of improving a peak rate and system capacity for a single user, a direct method is to increase a transmission bandwidth of a system. Carrier Aggregation (CA) is a technology for increasing the transmission bandwidth of a LTE-Advanced system.

The CA technology can aggregate 2 to 5 Long Term Evolution (LTE) Component Carriers (CC) together so as to realize a maximum transmission bandwidth of 100 MHz, which effectively improves uplink and downlink transmission rates. The mobile terminal can decide, according to capabilities thereof, a maximum number of carriers that can be used for uplink and downlink transmission.

With the popularization of the CA technology, in particular the uplink and downlink CA technology of multiple frequency bands, it is required that the mobile terminal should have a higher antenna isolation degree, higher antenna requirements, and a better system integration degree. However, in related technologies, implementation forms of the antenna in the mobile terminal are fixed. The antenna is usually implemented in the form of a flexible printed circuit (FPC) antenna, a laser-direct-structuring (LDS) antenna, or a metal antenna, or multiple combinations of the above forms, which makes it increasingly difficult for design of the antenna in a limited space. On one hand, when the mobile terminal supports multiple frequency bands, problems such as the isolation degree among different antennas need to be considered according to different solutions; and one the other hand, performance of wideband and multiband antennas is unsatisfactory due to space limitation of the mobile terminal, and conditions including space and environment complexity all cause restriction for the antenna to achieve a better state.

In this technological development background, it is desirable that one antenna achieve multiband and wideband index requirements, and that performance such as the isolation degree of multiple antennas meet the requirements as well. It is difficult for the antenna implementation forms in related technologies to meet the above design requirements.

### SUMMARY OF THE INVENTION

The present disclosure provides an antenna and an antenna control method, which occupies less space, and at the same time applies to changes of different communication scenarios and communication modes and meets multiband and wideband index requirements.

The present disclosure provides an antenna. The antenna includes: a substrate and a control circuit board, wherein the substrate is placed below the control circuit board, wherein,

the substrate is provided thereon with a matrix channel, wherein the matrix channel includes at least one liquid channel, each liquid channel being configured to hold a liquid that is in a liquid form at normal temperature and contains iron particles;

the control circuit board is provided thereon with a matrix coil corresponding to the matrix channel, wherein the matrix coil includes at least one conductive coil corresponding to the liquid channel; and

the control circuit board is configured to control, based on a shape of a required antenna, conducted conductive coils in the matrix coil to generate magnetic fields, and control, through the magnetic fields, a state change of the iron particles in liquid channels corresponding to respective conducted conductive coils, so as to form an antenna with a target shape.

Alternatively, the substrate is formed of one layer of substrate, and the control circuit board is formed of at least one layer of circuit board.

Alternatively, the conductive coils are wound in a same way and in a same direction, and each have an independent power supply.

Alternatively, the control circuit board is configured to:

control the conducted conductive coils in the matrix coil to generate magnetic fields that are directed perpendicularly towards the substrate, and control, through the magnetic fields that are directed perpendicularly towards the substrate, a state of the iron particles in the liquid channels corresponding to the respective conducted conductive coils to change from a free state to a concentrated state, so as to form an antenna with a target shape.

Alternatively, the antenna further includes: a control circuit and a power supply circuit, wherein the control circuit and the power supply circuit are configured to connect, via a control circuit line, with the control circuit board;

the control circuit is configured to: determine a corresponding matrix based on a shape of a required antenna, wherein the matrix includes M rows×N columns of matrix elements, wherein a value of matrix elements corresponding to the shape of the required antenna is 1, and a value of remaining matrix elements is 0; and

control conductive coils corresponding to the matrix elements with the value of 1 to be conducted, and control conductive coils corresponding to the matrix elements with the value of 0 not to be conducted;

wherein M and N are positive integers.

The present disclosure further provides an antenna control method. The antenna includes a substrate and a control circuit board, and the substrate is placed below the control circuit board, wherein the substrate is provided thereon with a matrix channel, and the control circuit board is provided thereon with a matrix coil; the matrix channel includes at least one liquid channel, each liquid channel being configured to hold a liquid that is in a liquid form at normal temperature and contains iron particles, and the matrix coil includes at least one conductive coil in a one-to-one correspondence relationship with the liquid channel; and the method includes steps of:

controlling, by the control circuit board, conducted conductive coils in the matrix coil to generate magnetic fields based on a shape of a required antenna; and

controlling, by the control circuit board, a state change of iron particles within liquid channels corresponding to respective conducted conductive coils through the magnetic fields, so as to form an antenna with a target shape.

Alternatively, the substrate is formed of one layer of substrate, and the control circuit board is formed of at least one layer of circuit board.

Alternatively, the conductive coils are wound in a same way and in a same direction, and each have an independent power supply.

Alternatively, the step of controlling conducted conductive coils in the matrix coil to generate magnetic fields includes:

controlling, by the control circuit board, the conducted conductive coils in the matrix coil to generate magnetic fields that are directed perpendicularly towards the substrate.

Alternatively, the step of controlling, by the control circuit board, conducted conductive coils in the matrix coil to generate magnetic fields based on a shape of a required antenna, includes:

determining, by the control circuit board, a corresponding matrix based on a shape of a required antenna, wherein the matrix includes M rows×N columns of matrix elements, wherein a value of matrix elements corresponding to the shape of the required antenna is 1, and a value of remaining matrix elements is 0; and

controlling conductive coils corresponding to the matrix elements with the value of 1 to be conducted, and controlling conductive coils corresponding to the matrix elements with the value of 0 not to be conducted;

wherein M and N are positive integers.

The antenna and the antenna control method provided by the present disclosure can control, based on a shape of a required antenna, a specified conductive coil in a matrix coil to be conducted, causing conducted conductive coils to generate magnetic fields, and further causing a state change of iron particles in a liquid channel, so as to form an antenna with a desired shape. In this way, an antenna with a desired target shape can be obtained according to actual application needs. By using embodiments of the present application, different shapes of the antenna can be obtained through conducting of conductive coils and a state change of corresponding iron particles without the need of adding a complex antenna structure. The antenna is relatively easy to design, and can save space and apply to different communication scenarios and communication modes.

In addition, there can be many kinds of state changes of the iron particles, and correspondingly there can be many kinds of shapes of the liquid antenna to be formed. Thus, a terminal using the CA technology can also receive signals of different communication frequencies by using different antenna shapes, which can improve a capability of multiplex reception of carrier signals of the antenna so as to meet multiband and wideband index requirements.

### BRIEF DESCRIPTION OF THE DRAWINGS

FIG. 1 is a schematic diagram of a structure of a liquid antenna according to an embodiment;

FIG. 2 is a schematic diagram of a rear shell of a mobile terminal according to an embodiment;

FIG. 3 is a schematic diagram of a structure of a substrate in the structure of a liquid antenna according to an embodiment;

FIG. 4 is a schematic diagram of a structure of a control circuit board in the structure of a liquid antenna according to an embodiment;

FIG. 5 is a schematic diagram of a structure of a conductive coil on a control circuit board in the structure of a liquid antenna according to an embodiment;

FIG. 6 is a schematic diagram of a shape of a liquid antenna according to an embodiment; and

FIG. 7 is a schematic diagram of a flowchart implementing an antenna control method of a liquid antenna according an embodiment.

### DETAILED DESCRIPTION OF THE EMBODIMENTS

The accompanying drawings are used only for reference and illustration, rather than limiting the present disclosure.

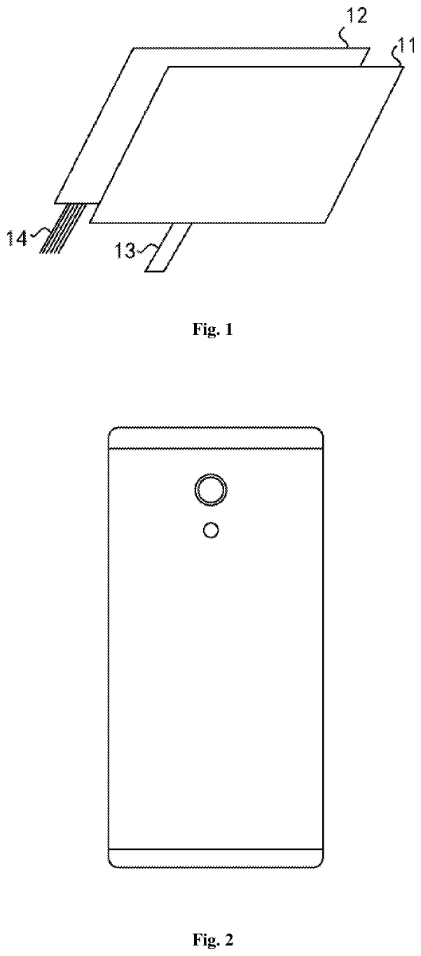

A structure of an antenna, for example, a liquid antenna, provided in embodiments of the present application, is as shown in FIG. 1. The liquid antenna includes: a substrate 11 and a control circuit board 12. The substrate 11 is placed under the control circuit board 12.

The substrate 11 is provided thereon with a matrix channel. The matrix channel includes at least one liquid channel, each liquid channel being used for holding a liquid that is in a liquid form at normal temperature and contains iron particles.

The liquid can contain metallic iron particles. However, the metallic iron particles are not dissolvable in the liquid, and do not take part in any other chemical reactions either. That is, a filler in the liquid channel may be a mixture of the liquid and the metallic iron particles.

The control circuit board 12 is provided thereon with a matrix coil corresponding to the matrix channel, the matrix coil including at least one conductive coil corresponding to the liquid channel.

The control circuit board 12 is configured to control conducted conductive coils in the matrix coil to each generate a magnetic field, and control a state change of the iron particles in liquid channels corresponding to respective conducted conductive coils, so as to form an antenna with a target shape.

Alternatively, the substrate 11 is formed of one layer of substrate, and the control circuit board 12 is formed of at least one layer of circuit board.

Alternatively, the substrate 11 is configured to connect with an antenna feeder, and the control circuit board 12 is configured to connect with a control circuit line 14.

Alternatively, the conductive coils are wound in a same way and in a same direction, and each have an independent power supply.

Alternatively, the control circuit board 12 is configured to control the conducted conductive coils in the matrix coil to each generate a magnetic field that is directed perpendicularly towards the substrate, and control a state of the iron particles in the liquid channels corresponding to the respective conducted conductive coils to change from a free state to a concentrated state, so as to form an antenna with a target shape.

Alternatively, the liquid antenna further includes: a control circuit and a power supply circuit. The control circuit and the power supply circuit are configured to connect, via a control circuit line 14, with the control circuit board 12.

The control circuit is configured to determine a corresponding matrix based on a shape of a required antenna. The matrix includes M rows×N columns of matrix elements. A value of matrix elements corresponding to the shape of the required antenna is 1, and a value of remaining matrix elements is 0. It is controlled that conductive coils corresponding to the matrix elements with the value of 1 are conducted, and that conductive coils corresponding to the matrix elements with the value of 0 are not conducted.

M and N are natural numbers. The number of the matrix elements may be determined based on density of the iron particles in the liquid channels of the required antenna. A maximum value of the number of the matrix elements includes but not limited to 24, and a minimum value of the number of the matrix elements includes but not limited to 12. The number of the matrix elements refers to the number of the matrix elements with the value of 1 in the M×N matrix elements.

The shape of the liquid antenna may be determined by employing two manners.

In a first manner, the shape of the liquid antenna is determined based on a network mode and a frequency band in which a terminal operates. In an actual application scenario, each terminal may support different network modes or communication schemes, for example, Global System for Mobile Communication (GSM), Wideband Code Division Multiple Access (W-CDMA), LTE, LTE-A and so on. Different communication schemes may include multiple frequency bands, and different frequency bands in different communication schemes correspond to different antennas. In other words, when the terminal operates in different communication schemes or in different frequency bands, different antennas are used. Therefore, it is required that the shape of the liquid antenna should be determined based on the network mode and the frequency band in which the terminal operates.

For instance, it is determined in advance, by assumption, that, if the terminal operates in a GSM900 frequency band, a shape of the liquid antenna used is represented by the letter Z; and if the terminal operates in a GSM1800 frequency band, a shape of the liquid antenna used is represented by the letter Y. If it is detected that the terminal currently operates in a network mode of GSM and in an operation frequency band of 900 MHz, it may be determined that the shape of the liquid antenna used by the terminal is the shape represented by the letter Z.

The above description is only a simple example. In actual application, shapes of the liquid antenna corresponding to respective network modes and frequency bands that the terminal supports may be determined in advance. In this way, after the network mode and the frequency band in which the terminal currently operates are detected, the shape of the liquid antenna used by the terminal may be determined.

In a second manner, the shape of the liquid antenna is determined by the network mode and the frequency band that the terminal supports in combination with a current state of the terminal. States of the terminal include but not limited to a state of being held in hand or a state of being used to make a call, and the states of the terminal may be obtained by different sensors within the terminal. The state of the terminal may be a state of being held with the left hand, a state of being held with the right hand, a state of being used to make a call with the terminal close to the right side of the head, a state of being used to make a call with the terminal close to the left side of the head, a free space state, or a state of being placed on the table, and so on. In actual application, for a terminal operating in a same communication system and in a same frequency band, if the terminal is in a different state, in order to achieve better transmission and reception effects, a different shape of the liquid antenna may be used. Different sensors may be used to determine different states of the terminal, i.e., whether or not the terminal is being used to make a call, which hand the terminal is held with, whether the terminal is close to the head, and so on. Based on the different states of the terminal, a proper shape of the liquid antenna may be used more precisely, so that differentiation of the shapes of the liquid antenna may be more precise and elaborate and that reception and transmission effects of the antenna may be better so as to further improve communication quality of the terminal.

For example, it is determined in advance, by assumption, that, if the terminal operates in the GSM900 frequency band and the state of the terminal is being held with the left hand, a shape of the liquid antenna used is represented by the letter N; if the terminal operates in the GSM900 frequency band and the state of the terminal is being held with the right hand, a shape of the liquid antenna used is represented by the letter H; and if the terminal operates in the GSM1800 frequency band and the state of the terminal is being used to make a call with terminal close to the left side of the head, a shape of the liquid antenna used is represented by the letter M. If it is detected that the terminal currently operates in a network mode of GSM and in an operation frequency band of 900 MHz with the state of being held with the left hand, it may be determined that the shape of the liquid antenna used by the terminal is the shape represented by the letter N. If it is detected that the terminal currently operates in the GSM network mode and in an operation frequency band of 1800 MHz with the state of being used to make a call with the terminal close to the left side of the head, it may be determined that the shape of the liquid antenna used by the terminal is the shape represented by the letter M.

The above descriptions are only simple examples. In actual application, shapes of the liquid antenna corresponding to respective network modes and frequency bands that the terminal supports and the states of the terminal may be determined in advance. In this way, after the network mode and the frequency band in which the terminal currently operates and a current state of the terminal are detected, the shape of the liquid antenna used by the terminal may be determined. As can be seen, in actual application, by using the implementation solutions provided by the embodiments of the present application, the shape of the liquid antenna used by the terminal can be enabled to change in time with the network mode, the frequency band, and the state of the terminal, so that the antenna can maintain better reception and transmission effects and that the terminal can achieve better communication quality.

In the embodiments of the present application, the liquid antenna including the matrix coil and the matrix channel may be fixed in any area on a rear shell of the mobile terminal. A schematic diagram of the rear shell of the mobile terminal is shown in FIG. 2, and FIG. 2 is a typical view of the rear shell of the mobile terminal. The rear shell of the mobile terminal is mostly made of plastics, glass, metal or a combination of the above. The liquid antenna in the embodiments of the present application may be a single antenna, or may be a combination of the liquid antenna and a metal member and the like which functions as an antenna.

In actual application, the control circuit may be implemented through a Central Processing Unit (CPU), a Micro Processor Unit (MPU), a Digital Signal Processor (DSP), or a Field Programmable Gate Array (FPGA) and so on which is located in the mobile terminal.

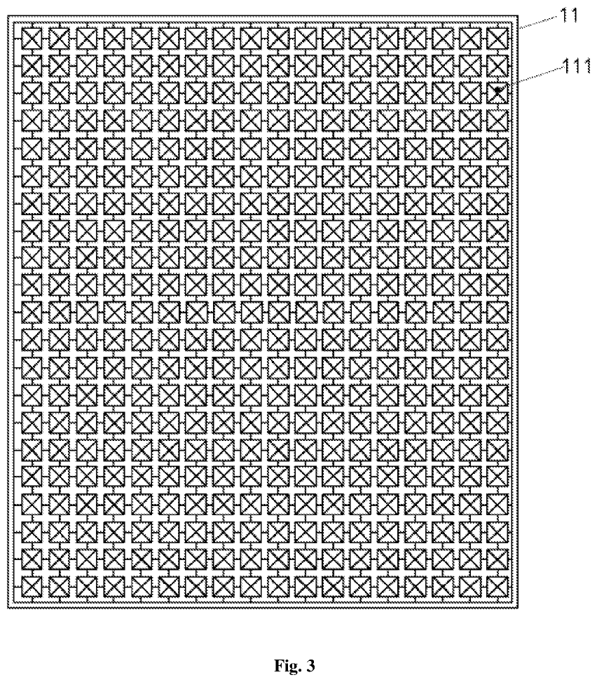

FIG. 3 is a schematic diagram of a structure of the substrate 11 of the liquid antenna. As shown in FIG. 3, the substrate 11 includes at least one liquid channel 111, the liquid channel 111 corresponding to one matrix element. Alternatively, the substrate has characteristics such as bending resistance, oxidation resistance and so on. Alternatively, polydimethylsiloxane is selected for making the substrate. Here, the substrate 11 may be called a liquid unit layer, and correspondingly, the liquid channel 111 is called a liquid unit.

For example, M×N liquid units are formed by etching within the polydimethylsiloxane substrate, and all the liquid units are connected with each other via a micropore, so as to form M rows and N columns of liquid units. Liquid in the liquid units may flow freely in the liquid units, and the liquid contains iron particles. The iron particles are not dissolvable in the liquid, and do not take part in any chemical reactions.

When the conductive coils on the control circuit board in the structure of the liquid antenna are not conducted, the conductive coils do not generate magnetic fields whose magnetic field directions are directed towards the substrate 11 at a lower layer. The iron particles in the liquid within the liquid units of the substrate 11 are in a free state, and do not form any shape of the antenna. At this time, iron particles do not have an antenna function, and have basically no influence on other antennas and radiators.

When at least one of the conductive coils on the control circuit board in the structure of the liquid antenna is conducted, each of the conducted conductive coils generates a magnetic field whose magnetic field direction is directed towards the substrate 11 at the lower layer. Under the influence of the magnetic fields, the iron particles within the liquid units of the substrate 11 at the lower layer are in a concentrated state and form an antenna with a target shape. At this time, the iron particles have an antenna function.

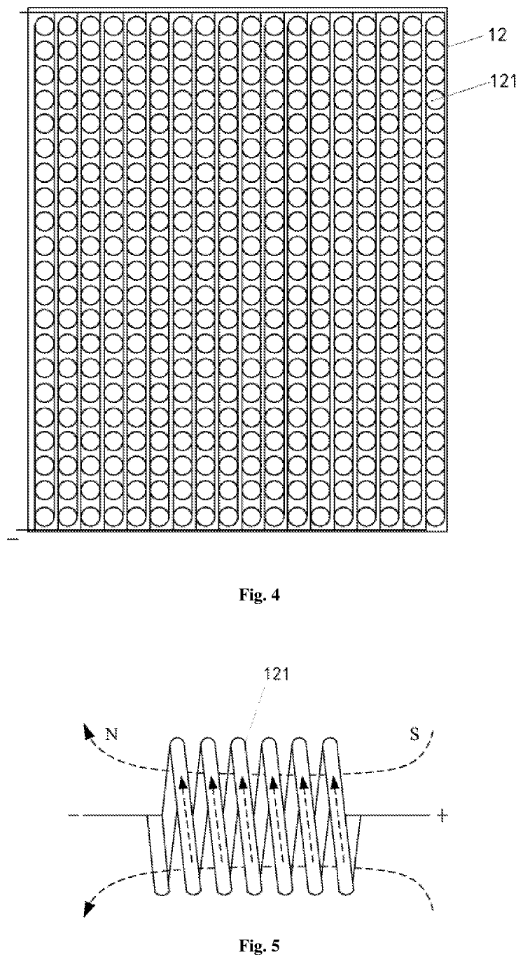

FIG. 4 is a schematic diagram of a structure of the control circuit board 12 in the structure of the liquid antenna provided in the embodiments of the present application. As shown in FIG. 4, the control circuit board 12 is made of at least one layer of flexible circuit. Corresponding to the liquid units in the liquid antenna, the control circuit board 12 is provided thereon with corresponding conductive coils 121. Each conductive coil 121 corresponds to one liquid unit in the liquid antenna. Here, the control circuit board 12 may be called a conductive unit layer.

The liquid unit layer has M×N liquid units, and correspondingly the conductive unit layer has M×N conductive coils 121 which are controlled independently.

The control circuit controls at least one of the conductive coils 121 on the control circuit board 121 to be conducted. Each conductive coil 121 has two states, i.e., a powered-on (conducted) state and a powered-off (non-conducted) state, which are respectively represented by 1 and 0.

States of the M×N liquid units in the liquid unit layer may form a matrix C_{MN},

$${C}_{MN} = [ \begin{matrix}{c}_{11} , & {c}_{12} , & … & {c}_{1 N} \\ {c}_{21} , & {c}_{22} , & … & {c}_{2 N} \\ ⋮ & ⋮ & ⋱ & ⋮ \\ {c}_{M 1} , & {c}_{M 2} , & … & {c}_{MN}\end{matrix} ] ,$$

in which, a matrix element c_{MN} in the matrix C_{MN} corresponds to a state of a liquid unit in the m^{th} row and the n^{th} column in the liquid unit layer; m is larger than or equal to 1 and smaller than or equal to M; n is larger than or equal to 1 and smaller than or equal to N; c_{MN} being 1 represents that the iron particles within the liquid unit is in the concentrated state; and c_{MN} being 0 represents that the iron particles within the liquid unit is in the free state. The Matrix C_{MN} and the shape of the antenna are in a one-to-one correspondence relationship.

By controlling the conducted conductive coils in the conductive unit layer to each generate a magnetic field that is directed perpendicularly towards the liquid unit layer, a state of the iron particles within the liquid units corresponding to respective conducted conductive coils in the liquid unit layer is controlled to change from the free state to the concentrated state so as to form an antenna with a target shape. Alternatively, the conductive unit layer is configured to connect with the control circuit and a power supply circuit via a wire.

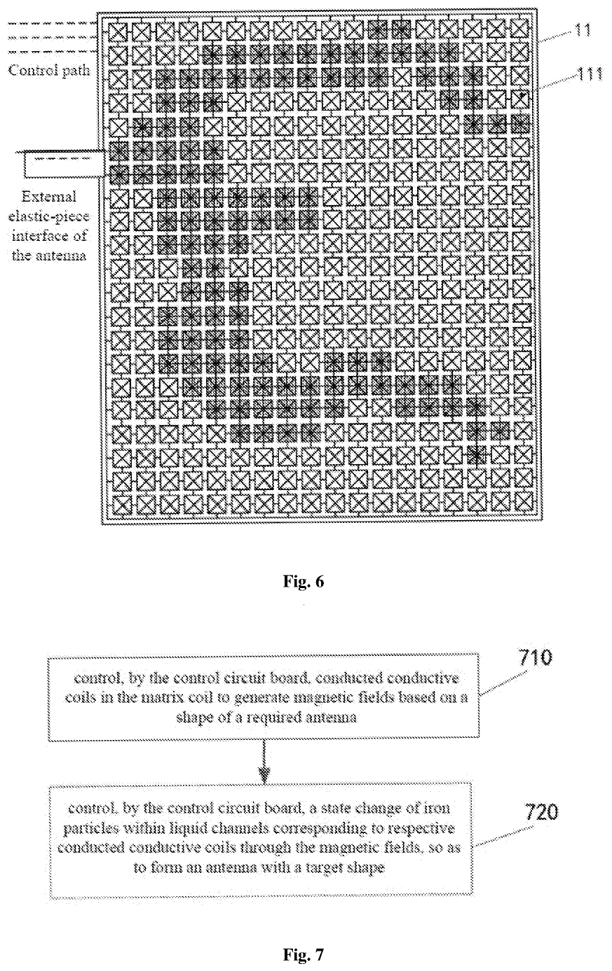

FIG. 5 is a schematic diagram of a structure of a conductive coil on the control circuit board in the structure of the liquid antenna provided in the embodiments of the present application. As shown in FIG. 5, in the present embodiment, power is supplied from a right side of the conductive coil 121, and a left side thereof is ground. A flowing direction of current in the conductive coil 121 is as shown by dashed arrows. According to the right-hand screw rule, for a magnetic field direction formed by the conductive coil 121, a left side is N pole, and a right side is S pole. When it is controlled that at least one conductive coil 121 is conducted, the at least one conductive coil 121 generates a magnetic field of the same direction. The magnetic field direction is directed perpendicularly towards the substrate 11, so that the state of the iron particles within the liquid units corresponding to respective conducted conductive coils in FIG. 3 is controlled to change from the free state to the concentrated state so as to form an antenna with a target shape (as shown in FIG. 6). In FIG. 6, a liquid channel 111 filled with black dots is used to represent a liquid unit (i.e., the liquid channel 111) in which the iron particles are in the concentrated state, and a liquid channel 111 filled with nothing is used to represent a liquid unit in which the iron particles are in the free state.

The shape of antenna shown in FIG. 6 is only an example. In Actual application, a shape of the corresponding liquid antenna may be determined based on the network mode and the frequency band of the terminal, or based on the network mode and the frequency band of the terminal together with the state of the terminal; then a matrix corresponding the shape of the liquid antenna is determined; and at last, corresponding conductive coils 121 are conducted according to a matrix C_{MN}, so as to form a target antenna.

An antenna control method is further provided in the embodiments of the present application. As shown in FIG. 7, the implementation procedures of the control method in the embodiments of the present application include the following step 710 and step 720.

The antenna includes a substrate and a control circuit board. The substrate is placed below the control circuit board. A matrix channel is arranged on the substrate, and a matrix coil is arranged on the control circuit board.

The matrix channel includes more than one liquid channels, each liquid channel being used for holding a liquid that is in a liquid form at normal temperature and contains iron particles; and the matrix coil includes more than one conductive coils corresponding to the liquid channels.

Alternatively, the substrate is formed of one layer of substrate, and the control circuit board is formed of at least one layer of circuit board.

Alternatively, the conductive coils are wound in a same way and in a same direction, and each have an independent power supply.

Referring to FIG. 7, the above method includes the following steps.

At step 710, the control circuit board controls, based on a shape of a required antenna, conducted conductive coils in the matrix coil to generate magnetic fields.

At step 720, the control circuit board controls, through the magnetic fields, a state change of iron particles within liquid channels corresponding to respective conducted conductive coils, so as to form an antenna with a target shape.

When a certain shape of the antenna is needed, the control circuit board controls, through the magnetic fields which are generated by respective conducted conductive coils and are directed perpendicularly towards the substrate, a state of the iron particles within the liquid channels corresponding to the respective conducted conductive coils to change from a free state to a concentrate state, so as to form the antenna with the target shape.

The liquid antenna may further include a control circuit and a power supply circuit, and the control circuit and the power supply circuit are configured to connect, via a control circuit line, with the control circuit board.

Alternatively, the step that the control circuit board controls, based on a shape of a required antenna, conducted conductive coils in the matrix coil to generate magnetic fields includes: determining a corresponding matrix based on the shape of the required antenna by the control circuit board. The matrix includes M rows×N columns of matrix elements. A value of matrix elements corresponding to the shape of the required antenna is 1, and a value of remaining matrix elements is 0. It is controlled that conductive coils corresponding to the matrix elements with the value of 1 are conducted and generate magnetic fields, and conductive coils corresponding to the matrix elements with the value of 0 are not conducted.

Here, M and N are positive integers. The number of the matrix elements may be determined based on density of the iron particles in the liquid channels of the liquid antenna. A maximum value of the number of the matrix elements includes but not limited to 24, and a minimum value of the number of the matrix elements includes but not limited to 12. The number of the matrix elements refers to the number of the matrix elements with the value of 1 in the M×N matrix elements.

The shape of the liquid antenna may be determined by employing two manners.

In a first manner, the shape of the liquid antenna is determined based on a network mode and a frequency band in which a terminal operates. In an actual application scenario, each terminal may support different network modes or communication schemes, for example, GSM, W-CDMA, LTE, LTE-A and so on. Different communication schemes may include multiple frequency bands, and different frequency bands in different communication schemes correspond to different antennas. In other words, when the terminal operates in different communication schemes or in different frequency bands, different antennas are used. Therefore, it is required that the shape of the liquid antenna should be determined based on the network mode and the frequency band in which the terminal operates.

Each shape of the liquid antenna may be determined in advance in a simulative operation environment of the terminal by a professional engineer specializing in antennas. For example, when it is simulated that the terminal operates in a certain frequency band of a certain communication scheme, the shape of the liquid antenna which corresponds to a state of the terminal in this operation environment and brings about best antenna performance is adjusted and tested. In actual application, when the network mode and the frequency band in which the terminal operates are detected, the liquid antenna may be controlled to form a shape of the antenna corresponding to the network mode and the frequency band. By using the corresponding shape of the antenna, optimal communication quality of the terminal can be achieved.

For instance, it is determined in advance, by assumption, that, if the terminal operates in a GSM900 frequency band, a shape of the liquid antenna used is represented by the letter Z; and if the terminal operates in a GSM1800 frequency band, a shape of the liquid antenna used is represented by the letter Y. If it is detected that the terminal currently operates in a network mode of GSM and in an operation frequency band of 900 MHz, it may be determined that the shape of the liquid antenna used by the terminal is the shape represented by the letter Z.

Based on the shape Z of the liquid antenna, the corresponding matrix elements with the value of 1 and the matrix elements with the value of 0 in the matrix are determined. After that, the conductive coils corresponding to the matrix elements with the value of 1 are conducted, and the conductive coils corresponding to the matrix elements with the value of 0 are not conducted, so as to obtain the liquid antenna having the shape Z for use by the terminal.

The above description is only a simple example. In actual application, shapes of the liquid antenna corresponding to respective network modes and frequency bands that the terminal supports may be determined in advance through adjustment and testing. In this way, after the network mode and the frequency band in which the terminal currently operates are detected, the shape of the liquid antenna used by the terminal may be determined.

In a second manner, the shape of the liquid antenna is determined by the network mode and the frequency band that the terminal supports in combination with a current state of the terminal. States of the terminal include but not limited to a state of being held in hand or a state of being used to make a call, and the states of the terminal may be obtained by different sensors within the terminal. The state of the terminal may be a state of being held with the left hand, a state of being held with the right hand, a state of being used to make a call with the terminal close to the right side of the head, a state of being used to make a call with the terminal close to the left side of the head, a free space state, or a state of being placed on the table, and so on. In actual application, for a terminal operating in a same communication system and in a same frequency band, if the terminal is in a different state, in order to achieve better transmission and reception effects, a different shape of the liquid antenna may be used. Different sensors may be used to determine different states of the terminal, i.e., whether or not the terminal is being used to make a call, which hand the terminal is held with, whether the terminal is close to the head, and so on. Based on the different states of the terminal, a proper shape of the liquid antenna may be used more precisely, so that differentiation of the shapes of the liquid antenna may be more precise and elaborate and that reception and transmission effects of the antenna may be better so as to further improve communication quality of the terminal.

Each shape of the liquid antenna may be determined in advance in a simulative operation environment of the terminal by a professional engineer specializing in antennas. For example, when it is simulated that the terminal operates in a certain frequency band of a certain communication scheme, the shape of the liquid antenna which corresponds to a state of the terminal in this operation environment and brings about best antenna performance is adjusted and tested based on the state of the terminal. In actual application, when the network mode and the frequency band in which the terminal operates are detected, the liquid antenna may be controlled to form a shape of the liquid antenna corresponding to the network mode, the frequency band, and the state of the terminal. By using the corresponding shape of the antenna, optimal communication quality of the terminal can be achieved.

For instance, it is determined in advance, by assumption, that, if the terminal operates in a GSM900 frequency band and the state of the terminal is being held with the left hand, a shape of the liquid antenna used is represented by the letter N; if the terminal operates in the GSM900 frequency band and the state of the terminal is being held with the right hand, a shape of the liquid antenna used is represented by the letter H; if the terminal operates in a GSM1800 frequency band and the state of the terminal is being used to make a call with terminal close to the left side of the head, a shape of the liquid antenna used is represented by the letter M. If it is detected that the terminal currently operates in a network mode of GSM, in an operation frequency band of 900 MHz, and in the state of being held with the left hand, it may be determined that the shape of the liquid antenna used by the terminal is the shape represented by the letter N. Based on the shape N of the liquid antenna, the corresponding matrix elements with the value of 1 and the matrix elements with the value of 0 in the matrix are determined. After that, the conductive coils corresponding to the matrix elements with the value of 1 are conducted, and the conductive coils corresponding to the matrix elements with the value of 0 are not conducted, so as to obtain the liquid antenna having the shape N for use by the terminal.

If it is detected that the terminal currently operates in a network mode of GSM, in an operation frequency band of 1800 MHz, and in the state of being used to make a call with terminal close to the left side of the head, it may be determined that the shape of the liquid antenna used by the terminal is the shape represented by the letter M. Based on the shape M of the liquid antenna, the corresponding matrix elements with the value of 1 and the matrix elements with the value of 0 in the matrix are determined. After that, the conductive coils corresponding to the matrix elements with the value of 1 are conducted, and the conductive coils corresponding to the matrix elements with the value of 0 are not conducted, so as to obtain the liquid antenna having the shape M for use by the terminal.

The above descriptions are only examples. In actual application, shapes of the liquid antenna corresponding to respective network modes and frequency bands that the terminal supports and the states of the terminal may be determined in advance by adjustment and testing. In this way, after the network mode and the frequency band in which the terminal currently operates and a current state of the terminal are detected, the shape of the liquid antenna used by the terminal may be determined. In actual application, by using the implementation solutions provided by the embodiments of the present application, the shape of the liquid antenna used by the terminal may change in time with the network mode, the frequency band, and the state of the terminal, so that the antenna can maintain better reception and transmission effects and that the terminal can achieve better communication quality.

### INDUSTRIAL APPLICABILITY

According to the antenna and the antenna control method provided by the present disclosure, different shapes of the antenna can be obtained by conducting of conductive coils and a state change of corresponding iron particles. The antenna has a simple structure, a low degree of design difficulty, and a small size, and can apply to multiple communication scenarios and communication modes.

1. An antenna, comprising: a substrate and a control circuit board, wherein the substrate is placed below the control circuit board, wherein,
the substrate is provided thereon with a matrix channel, wherein the matrix channel comprises at least one liquid channel, each liquid channel being configured to hold a liquid that is in a liquid form at normal temperature and contains iron particles;
the control circuit board is provided thereon with a matrix coil corresponding to the matrix channel, wherein the matrix coil comprises at least one conductive coil corresponding to the liquid channel; and
the control circuit board is configured to control, based on a shape of a required antenna, conducted conductive coils in the matrix coil to generate magnetic fields, and control, through the magnetic fields, a state change of iron particles in liquid channels corresponding to respective conducted conductive coils, so as to form an antenna with a target shape.

2. The antenna according to claim 1, wherein, the substrate is formed of one layer of substrate, and the control circuit board is formed of at least one layer of circuit board.

3. The antenna according to claim 1, wherein, the conductive coils are wound in a same way and in a same direction, and each have an independent power supply.

4. The antenna according to claim 1, wherein, the control circuit board is configured to:
control the conducted conductive coils in the matrix coil to generate magnetic fields that are directed perpendicularly towards the substrate, and control, through the magnetic fields that are directed perpendicularly towards the substrate, a state of the iron particles in the liquid channels corresponding to the respective conducted conductive coils to change from a free state to a concentrated state, so as to form an antenna with a target shape.

5. The antenna according to claim 1, wherein, the antenna further comprises: a control circuit and a power supply circuit, wherein the control circuit and the power supply circuit are configured to connect, via a control circuit line, with the control circuit board,
the control circuit is configured to: determine a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
control conductive coils corresponding to the matrix elements with the value of 1 to be conducted, and control conductive coils corresponding to the matrix elements with the value of 0 not to be conducted,
wherein M and N are positive integers.

6. An antenna control method, wherein, the antenna comprises a substrate and a control circuit board, and the substrate is placed below the control circuit board, wherein the substrate is provided thereon with a matrix channel, and the control circuit board is provided thereon with a matrix coil; the matrix channel comprises at least one liquid channel, each liquid channel being configured to hold a liquid that is in a liquid form at normal temperature and contains iron particles, and the matrix coil comprises at least one conductive coil in a one-to-one correspondence relationship with the liquid channel; and the method comprises steps of:
controlling, by the control circuit board, conducted conductive coils in the matrix coil to generate magnetic fields based on a shape of a required antenna; and
controlling, by the control circuit board, a state change of iron particles within liquid channels corresponding to respective conducted conductive coils through the magnetic fields, so as to form an antenna with a target shape.

7. The method according to claim 6, wherein, the substrate is formed of one layer of substrate, and the control circuit board is formed of at least one layer of circuit board.

8. The method according to claim 6, wherein, the conductive coils are wound in a same way and in a same direction, and each have an independent power supply.

9. The method according to claim 6, wherein, the step of controlling conducted conductive coils in the matrix coil to generate magnetic fields comprises:
controlling, by the control circuit board, the conducted conductive coils in the matrix coil to generate magnetic fields that are directed perpendicularly towards the substrate.

10. The method according to claim 6, wherein, the step of controlling, by the control circuit board, conducted conductive coils in the matrix coil to generate magnetic fields based on a shape of a required antenna, comprises:
determining, by the control circuit board, a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
controlling conductive coils corresponding to the matrix elements with the value of 1 to be conducted, and controlling conductive coils corresponding to the matrix elements with the value of 0 not to be conducted,
wherein M and N are positive integers.

11. The method according to claim 7, wherein, the step of controlling, by the control circuit board, conducted conductive coils in the matrix coil to generate magnetic fields based on a shape of a required antenna, comprises:
determining, by the control circuit board, a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
controlling conductive coils corresponding to the matrix elements with the value of 1 to be conducted, and controlling conductive coils corresponding to the matrix elements with the value of 0 not to be conducted,
wherein M and N are positive integers.

12. The method according to claim 8, wherein, the step of controlling, by the control circuit board, conducted conductive coils in the matrix coil to generate magnetic fields based on a shape of a required antenna, comprises:
determining, by the control circuit board, a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
controlling conductive coils corresponding to the matrix elements with the value of 1 to be conducted, and controlling conductive coils corresponding to the matrix elements with the value of 0 not to be conducted,
wherein M and N are positive integers.

13. The method according to claim 9, wherein, the step of controlling, by the control circuit board, conducted conductive coils in the matrix coil to generate magnetic fields based on a shape of a required antenna, comprises:
determining, by the control circuit board, a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
controlling conductive coils corresponding to the matrix elements with the value of 1 to be conducted, and controlling conductive coils corresponding to the matrix elements with the value of 0 not to be conducted,
wherein M and N are positive integers.

14. The antenna according to claim 2, wherein, the antenna further comprises: a control circuit and a power supply circuit, wherein the control circuit and the power supply circuit are configured to connect, via a control circuit line, with the control circuit board,
the control circuit is configured to: determine a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
control conductive coils corresponding to the matrix elements with the value of 1 to be conducted, and control conductive coils corresponding to the matrix elements with the value of 0 not to be conducted,
wherein M and N are positive integers.

15. The antenna according to claim 3, wherein, the antenna further comprises: a control circuit and a power supply circuit, wherein the control circuit and the power supply circuit are configured to connect, via a control circuit line, with the control circuit board,
the control circuit is configured to: determine a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
control conductive coils corresponding to the matrix elements with the value of 1 to be conducted, and control conductive coils corresponding to the matrix elements with the value of 0 not to be conducted,
wherein M and N are positive integers.

16. The antenna according to claim 4, wherein, the antenna further comprises: a control circuit and a power supply circuit, wherein the control circuit and the power supply circuit are configured to connect, via a control circuit line, with the control circuit board,
the control circuit is configured to: determine a corresponding matrix based on a shape of a required antenna, wherein the matrix comprises M rows×N columns of matrix elements, wherein a value of matrix elements corresponding to the shape of the required antenna is 1, and a value of remaining matrix elements is 0; and
control conductive coils corresponding to the matrix elements with the value of 1 to be conducted, and control conductive coils corresponding to the matrix elements with the value of 0 not to be conducted,
wherein M and N are positive integers.
